(19) United States
(12) Patent Application Publication
(10) Pub. No.: US 2025/0121333 A1
(43) Pub. Date: Apr. 17, 2025

(54) Advanced carbon molecular sieve membranes derived from composite polyimide hollow fiber precursors

(71) Applicant: Georgia Tech Research Corporation, Atlanta, GA (US)

(72) Inventors: William J. Koros, Atlanta, GA (US); Yuhe Cao, Smyrna, GA (US)

(21) Appl. No.: 18/910,650

(22) Filed: Oct. 9, 2024

Related U.S. Application Data
(60) Provisional application No. 63/544,349, filed on Oct. 16, 2023.

(51) Int. Cl. B01D 71/02; B01D 63/02; B01D 63/04; B01D 69/08; B01D 71/64

(52) U.S. Cl. CPC B01D 71/021; B01D 63/023; B01D 63/04; B01D 69/088; B01D 71/024; B01D 71/643; B01D 2323/21813; B01D 2323/42; B01D 2323/60

(57) ABSTRACT

In a method of fabricating high performance CMS membranes, in which a dual-layer hollow fiber precursor fiber membrane that contains a nano-particle-filler containing core layer is extruded, a sheath layer is co-extruded with the core layer so that at least a portion of the core layer is surrounded by the sheath layer. The nano-particle filler is defect sealed. The dual-layer hollow fiber precursor fiber and the sheath layer are pyrolysed. A CMS membrane includes a core layer, a sheath layer surrounding at least a portion of the core layer and a plurality of nanoparticles disposed in the core layer.

### CROSS-REFERENCE TO RELATED APPLICATION

This application claims the benefit of US Provisional Patent Application Ser. No. 63/544,349, filed Oct. 16, 2023, the entirety of which is hereby incorporated herein by reference.

### BACKGROUND OF THE INVENTION

### 1. Field of the Invention

The present invention relates to molecular sieve membranes and, more specifically, carbon molecular sieve membranes.

### 2. Description of the Related Art

Processes using carbon molecular sieve (CMS) membranes upgrade the value of gas streams by efficiently separating components from various feed sources. Examples of such applications include removing carbon dioxide (CO2) and hydrogen sulfide (H2S) from natural gas streams; separation of propylene (C3H6) from propane (C3H8) and ethylene (C2H4) from ethane (C2H6) in hydrocarbon mixtures; and separation of oxygen (O2) from air. In these examples one or more valuable products can be separated from a less valuable feed stream in an energy efficient manner. Asymmetric multilayer CMS hollow fiber membranes are preferred for large scale high pressure applications due to their ability to be formed into compact modules with high surface-to-module volume properties.

Dense flat polymer films can be used as precursors for forming CMS membranes, but the productivity of these membranes tends to be low. To increase the surface to volume packing, precursor asymmetric polymer fibers used to form CMS membranes can be formed in a so-called dry-jet/wet-quench spinning process. These precursors are also known to be useful for forming CMS membranes. Important functional properties of CMS hollow fiber membranes include permeance and selectivity. Permeance measures the pressure-normalized flux of a given penetrant and provides a measure of membrane productivity. Selectivity measures the comparative ability of different gases to permeate through a membrane and provides a measure of separation efficiency. These properties and the methods by which asymmetric multilayer CMS hollow fiber membranes may be tested to determine these properties. Pyrolysis of appropriate precursor fibers at temperatures above the glass transition temperature (T_{g}) of the polymer creates a CMS fiber. Unfortunately, since the pyrolysis occurs above the polymer T_{g}, partial or even total collapse of the porous core layer often occurs. This collapse creates a separation layer that is much thicker and that has a much lower permeance, and is therefore much less productive, than would be expected if the collapse could be avoided. Substructure morphology collapse occurs when high temperatures during pyrolysis relax the polymer chains in the porous core layer. The movement of the polymer segments allows collapse of the substructure, thereby undermining the productivity advantage provided by the asymmetric fiber.

In one method for post-treating precursor fibers in order to limit substructure collapse during pyrolysis, precursor fibers are soaked in a chemical modifying agent, such as vinyl trimethoxy silane (VTMS), before pyrolysis and asymmetric multilayer CMS hollow fibers having an increased permeance are formed. The chemical modifying agent stabilizes the precursor fiber prior to pyrolysis to prevent collapse of the substructure morphology between the polymer T_{g} and the point of actual carbon formation. The above approach, although workable, requires an additional post-treatment step, thereby adding cost and complexity.

Performance of CMS membranes, prepared from polymeric precursor membranes, is affected significantly by precursor properties. During carbon formation, polymer precursors undergo transformation to create amorphous cellular structures dispersed within an amorphous continuous phase of randomly packed strands. Ultramicroporous (<7 Å) walls with slits between the strands in the walls, create precise angstrom-level penetrant discrimination. Micropores between the ultramicroporous carbon plates give high Langmuir sorption and enable long diffusion jump lengths for gas molecules. Such features are determined by precursor physio-chemical properties and pyrolysis conditions during the CMS formation. Asymmetric hollow fiber CMS membranes are more complex than dense film CMS but are preferred for large scale applications to create compact modules with high surface area-to-module volume ratios.

Asymmetric hollow fiber precursor membranes include three layers: an outer dense molecularly selective layer, a mesoporous transition support layer, and a larger pore primary support layer. Partial or even total collapse can occur in these three layers during pyrolysis, which exceeds the polymer glass transition temperature T_{g}. In-situ sol-gel VTMS pretreatment of precursor fiber membranes can mitigate the substructure collapse problem. However, VTMS on the fiber skin layer may add nonselective mass transfer resistance to permeation.

Nanoparticle-filler-containing support layer fibers have also shown attractive substructure stabilization features, and can be fabricated by either co-extrusion or dip-coating. Defect-free co-extruded precursor fiber membranes need to be spun prior to CMS formation. Also, dip-coating typically can require the precursor fibers to be in spool form for continuous coating processes, which increases the complexity of the precursor fiber fabrication process.

Therefore, there is a need for a method of making a CMS membranes that reduces substructure collapse.

### SUMMARY OF THE INVENTION

The disadvantages of the prior art are overcome by the present invention which, in one aspect, is a method of fabricating high performance CMS membranes, in which a dual-layer hollow fiber precursor fiber membrane that contains a nano-particle-filler containing core layer is extruded. A sheath layer is co-extruded with the core layer so that at least a portion of the core layer is surrounded by the sheath layer. The nano-particle filler is defect sealed. The dual-layer hollow fiber precursor fiber and the sheath layer are pyrolysed.

In another aspect, the invention is a process for making CMS membranes, in which a dual-layer hollow fiber precursor fiber membrane that contains a nano-particle-filler containing core layer surrounded by a sheath layer is co-extruded. The nano-particle-filler precursor fiber membrane is defect sealed. The core layer and the sheath layer are pyrolysed.

In yet another aspect, the invention is a CMS membrane that includes a core layer, a sheath layer surrounding at least a portion of the core layer and a plurality of nanoparticles disposed in the core layer.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram showing a dry-jet/wet-quench process for producing precursor hollow fiber membranes.

FIG. 2 is a schematic diagram of one embodiment of a pyrolysis system.

FIG. 3A-3D are SEM images of ST 5 precursor fiber membranes (SP-3 with 1% DETDA/TMC hybridization), in which FIG. 3A shows a cross section; FIG. 3B and FIG. 3C show fiber wall; and FIG. 3D shows top layer of the sheath layer.

FIGS. 4A-4D are SEM images of CMS membranes from ST5 (SP-3) with 1% DETDA/TMC hybridization by using S-675 pyrolysis, in which FIG. 4A shows a cross section; FIG. 4B shows a fiber wall; FIG. 4C and FIG. 4D show a carbon layer derived from sheath layer and core with different magnifications.

FIGS. 5A-5F are SEM images of ST 1 precursor fiber membranes (SP-4 Matrimid® 5218-1/(Matrimid® 5218-1+SiO₂)), in which FIG. 5A shows a cross section; FIG. 5B shows a fiber wall; FIG. 5C shows a bore side of the core layer; FIG. 5E shows a sheath layer; and FIG. 5F shows a sheath top layer.

FIGS. 6A-6B are charts showing CO₂/CH₄ separation performance form ST 1 of SP-4 Matrimid® 5218-1/(Matrimid® 5218-1+SiO₂) composite with different final pyrolysis temperature, where FIG. 6A shows S-550; and FIG. 6B shows S 675.

FIGS. 7A-7F are SEM images of CMS membranes from ST1 (SP-4 Matrimid® 5218-1/(Matrimid® 5218-1+SiO₂)) with 1% DETDA/TMC hybridization by using different pyrolysis protocols, in which FIGS. 7A, 7B and 7C show) S-550 pyrolysis; and FIGS. 7D, 7E and 7F show S-675 pyrolysis.

FIG. 8 is a chart showing CO₂ permeances & CO₂/CH₄ selectivity in ST1 (SP-4) with 1% DETDA/TMC at S-675 pyrolyzed CMS hollow fiber membranes under different feed pressures in which the permeation measurements were done with 50/50 CO₂/CH₄ at 35° C.

FIG. 9 is an image showing good mechanical flexibility of CMS hollow fiber membrane (ST 1 SP-4 at S-675° C.).

FIG. 10 is a chart showing H₂/CH₄ separation performance of 1% DETDA/TMC hybridized ST 1 (SP-4) with different final pyrolysis temperature.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

U.S. Pat. No. 10,500,548, entitled “Composite nanoparticle stabilized core carbon molecular sieve hollow fiber membranes having improved permeance” (Koros et al.) discloses basic methods of making CMS sieve hollow fiber membranes and is hereby incorporated herein by reference.

A defect caulking approach can be applied to seal defects from the precursor fiber membranes prior to pyrolysis. Also a simple thermal soaking step at 400° C. introduced in the pyrolysis can be used to obtain high performance CMS membranes. The composite CMS membranes show CO₂/CH₄ (50:50) mixed gas feed with an attractive CO₂/CH₄ selectivity of 134.2 and CO₂ permeance of 71.1 GPU at 35° C. Furthermore, a H₂/CH₄ selectivity of 662.6 with H₂ permeance of 239.6 GPU was achieved for promising green energy resource-H₂ separation processes.

A diethyltoluenediamine (DETDA)+trimesoyl chloride (TMC) hybridization process is employed to fabricate nanoparticle-filler-containing composite CMS membranes with excellent gas separation performance. This step avoids the need to spin defect-free nanoparticle-filler-containing support layer precursor fiber and decreases spinning difficulty greatly. The nanoparticle-filler in the core layer can effectively suppress the membrane matrix collapse during pyrolysis, and the VTMS step is eliminated for this embodiment-thereby greatly simplifying the CMS fabrication process.

Materials: In one experimental embodiment, a thermoplastic polyimide, such as Matrimid® 5218-1 was supplied by Huntsman Chemical Co in powder form. 6FDA:BPDA-DAM was synthesized via condensation reaction between 4,4′-(hexafluoroisopropylidene) diphthalic (6FDA) and 3,3′-4,4′-biphenyl tetracarboxylic acid (BPDA) dianhydrides with 2,4,6-trimethyl-1,3-diaminobenzene (DAM). Commercial silicon dioxide nanoparticles (Product #US3448, US Research Nanomaterials, Inc.) were utilized to make the core layer of the dual-layer hollow fiber. Nanoparticles having a bulk density of 0.056 g/cm³ with 15 nm average particle size were used. Trimesoyl chloride (TMC), poly(ethylene oxide) (PEO, 200,000 MW) and lithium nitrate were obtained from Sigma-Aldrich (St. Louis, MO). Sure-seal bottles of 1-methyl-2-pyrrolidine (NMP), ethanol, tetrahydrofuran (THF) and acetone were purchased from Sigma-Aldrich (St Louis, MO). Diethyltoluenediamine (DETDA) was purchased from Albemarle Corporation (Charlotte, NC). All chemicals were used without further purification. Methanol (20 L) and hexane (20 L) were purchased from BDH Chemicals Co. Pure-component H₂, N₂, O₂, and CH₄ gases (Research Grade Quality) were purchased from Airgas (Radnor Township, PA), while 50:50 CO₂:CH₄ mixed gas (±1% blend accuracy) was purchased from Nexair (Memphis, TN). All fittings used for module making were purchased from Swagelok® Georgia.

### Experimental Embodiment Fabrication:

### 6FDA:BPDA-DAM/Matrimid® 5218-1+SiO₂ Dual-Layer Hollow Fiber CMS Membrane Preparation and Characterization

### Precursor Fiber Membrane Preparation

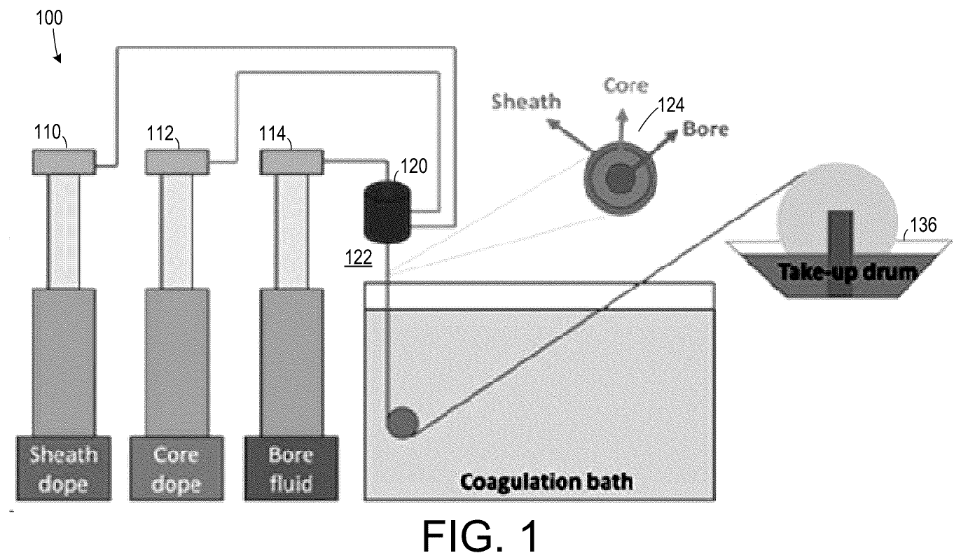

In the experimental embodiment, polymers and silicon dioxide nanoparticles were first dried in a vacuum oven at 110° C. overnight to remove moisture. A sonication bath was used to assist the nanoparticle dispersion, and sonication was stopped when no visible agglomerates could be observed. NMP solution containing 10 wt. % of the Matrimid® 5218-1 polymer was slowly added to the silicon dioxide dispersion. The remaining solvent and dried polymer solids were then added to provide the core spinning dope. Spinning dope components were added to Qorpak® glass jar sealed with a Teflon® cap, and sheath and core dope compositions are listed below in Tables 1, 3, and 5 for batch 1 (SP-1), batch 2 (SP-2) and batch 3 (SP-3), respectively. Each mixture was dissolved by placing the jar on a roller first at ˜50° C. for 24 h, followed by further rolling at room temperature to produce a homogeneous dope. The as-prepared sheath and core dopes were loaded into two syringe pumps (ISCO Inc., Lincoln, NE) respectively and allowed to degas overnight at 65° C. The bore fluid (87 wt. % NMP and 13 wt. % H₂O) was loaded into a separate syringe pump. The dual-layer hollow fiber membranes were prepared by the standard dry-jet/wet-quench spinning process, as shown in FIG. 1. A sheath dope 110 and a core dope 112 were simultaneously extruded from a multi channel spinneret 120 around a bore fluid 114 forming a hollow fiber line 124 and passed through an air gap 122, followed by immersing into a water quench bath 130. The phase-separated hollow fiber line was then collected on a rotating polyethylene drum 136. Several spinning parameters (dope flow rate and bore fluid flow rate) were adjusted to obtain dual-layer fiber membranes with a variety of properties. As is shown in Tables 2, 4, and 6 below for batch 1, batch 2 and batch 3, respectively, precursor fiber membranes were prepared with those conditions. After spinning, the fibers were soaked in water baths for 3 days to remove the residual solvents and pore formers. The fibers were then solvent exchanged in glass containers with three separate 20 min methanol baths followed by three separate 20 min hexane baths and dried under vacuum at 75° C. for 3 hours.

TABLE 1
Dope composition of core spinning dope and sheath spinning
dope to spin 6FDA: BPDA-DAM/Matrimid ® 5218-1 dual-layer
fiber membranes (the 1^{st} spinning batch, SP-1).
Dope composition

| | Sheath (6FDA: BPDA-DAM) | Core (Matrimid ® 5218-1) |
|---|---|---|
| Component | Wt. % | Wt. % |
| polymer | 20.0 | 22.0 |
| NMP | 47.5 | 72.4 |
| THF | 10.0 | 0.0 |
| Ethanol | 16.0 | 0.0 |
| LiNO₃ | 6.5 | 0.0 |
| SiO₂ | 0.0 | 5.6 |

TABLE 2
Spinning parameters for 6FDA: BPDA-DAM/Matrimid ® 5218-1
dual-layer hollow fiber membranes (the 1^{st} spinning batch, SP-1).

| Spinning parameter | Value |
|---|---|
| Spinning temperature (° C.) | 65 |
| Quench bath temperature (° C.) | 50 |
| Sheath dope flow rate (cc/h) | 3 |
| Core dope flow rate (cc/h) | 200 |
| Bore fluid flow rate (cc/h) | 60 |
| Air gap (cm) | 7 |
| Fiber take-up rate (m/min) | 20 |

TABLE 3
Dope composition of core spinning dope and sheath spinning
dope to spin 6FDA: BPDA-DAM/Matrimid ® 5218-1 dual-layer
fiber membranes (the 2^{nd} spinning batch, SP-2).
Dope composition

| | Sheath (6FDA: BPDA-DAM) | Core (Matrimid ® 5218-1) |
|---|---|---|
| Component | Wt. % | Wt. % |
| polymer | 21.4 | 22.0 |
| NMP | 50.8 | 72.4 |
| THE | 10.7 | 0.0 |
| Ethanol | 17.1 | 0.0 |
| LiNO₃ | 0.0 | 0.0 |
| SiO₂ | 0.0 | 5.6 |

TABLE 4
Spinning parameters and O₂/N₂ separation performance for
6FDA: BPDA-DAM/Matrimid ® 5218-1 dual-layer
hollow fiber membranes (the 2^{nd} spinning batch, SP-2).

| Spinning parameter and | | | | |
|---|---|---|---|---|
| O₂/N₂ separation | State 1 | | | |
| performance | (ST 1) | ST 2 | ST 3 | ST 4 |
| Spinning temperature (° C.) | 65 | 65 | 65 | 65 |
| Quench bath temperature | 50 | 50 | 50 | 50 |
| (° C.) | | | | |
| Sheath dope flow rate (cc/h) | 10 | 15 | 20 | 30 |
| Core dope flow rate (cc/h) | 180 | 180 | 180 | 180 |
| Bore fluid flow rate (cc/h) | 60 | 60 | 60 | 60 |
| Air gap (cm) | 10 | 10 | 10 | 10 |
| Fiber take-up rate (m/min) | 21 | 21 | 21 | 21 |
| O₂ permeance (GPU) | 1817.0 | 1798.2 | 2209.7 | 2819.9 |
| N₂ permeance (GPU) | 1499.5 | 1646.1 | 2054.7 | 3249.5 |
| α_{O2/N2} | 1.21 | 1.09 | 1.08 | 0.87 |

TABLE 5
Dope composition of core spinning dope and sheath spinning dope
to spin 6FDA: BPDA-DAM/Matrimid ® 5218-1 dual-layer fiber
membranes (the 3^{rd} spinning batch, SP-3).
Dope composition

| | Sheath (6FDA: BPDA-DAM) | Core (Matrimid ® 5218-1) |
|---|---|---|
| Component | Wt. % | Wt. % |
| polymer | 21.4 | 22.0 |
| NMP | 50.8 | 66.4 |
| THF | 10.7 | 0.0 |
| Ethanol | 17.1 | 0.0 |
| LiNO₃ | 0.0 | 6.0 |
| SiO₂ | 0.0 | 5.6 |

TABLE 6
Spinning parameters and O₂/N₂ separation performance for
6FDA: BPDA-DAM/Matrimid ® 5218-1 dual-layer hollow
fiber membranes (the 3^{rd} spinning batch, SP-3).

| Spinning parameter and | | | | | |
|---|---|---|---|---|---|
| O₂/N₂ separation | | | | | |
| performance | ST 1 | ST 2 | ST 3 | ST 4 | ST 5 |
| Spinning temperature | 65 | 65 | 65 | 65 | 65 |
| (° C.) | | | | | |
| Quench bath | 50 | 50 | 50 | 50 | 50 |
| temperature (° C.) | | | | | |
| Sheath dope flow rate | 10 | 15 | 20 | 30 | 10 |
| (cc/h) | | | | | |
| Core dope flow rate | 150 | 150 | 150 | 150 | 180 |
| (cc/h) | | | | | |
| Bore fluid flow rate | 60 | 60 | 60 | 60 | 60 |
| (cc/h) | | | | | |
| Air gap (cm) | 10 | 10 | 10 | 10 | 10 |
| Fiber take-up rate | 7 | 7 | 7 | 7 | 7 |
| (m/min) | | | | | |
| O₂ permeance (GPU) | 1164.9 | 1198.9 | 775.0 | 978.4 | 270.7 |
| N₂ permeance (GPU) | 1147.1 | 1218.7 | 754.6 | 998.6 | 170.8 |
| α_{O2/N2} | 1.02 | 0.98 | 1.03 | 0.98 | 1.59 |

### Hollow Fiber CMS Membrane Preparation.

The vacuum dried fiber membranes were hybridized with 1-2 wt. % DETDA/1-2 wt. % TMC (DETDA+TMC) as described in U.S. Pat. No. 10,500,548. Briefly, the end-sealed fiber membranes were first soaked in a 1 wt. % DETDA/99 wt. % hexane solution for 30 mins. Then the DETDA/hexane solution was drained and a 1 wt. % TMC/99 wt. % hexane solution was applied to soak these fiber membranes for another 30 mins. After the TMC/hexane solution was drained, the fiber membranes were dried in a vacuum oven at 150° C. for 24 hours. Alter nativity, 2 wt. % DETDA/98 wt. % hexane solution and 2 wt. % TMC/98 wt. % hexane solution were used for higher concentration DETDA+TMC hybridization.

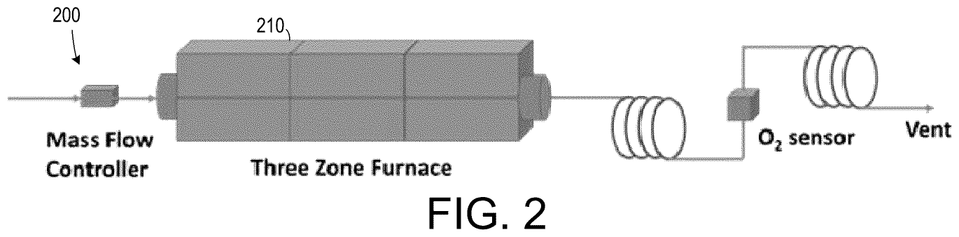

The fiber membranes with and without DETDA+TMC hybridization were pyrolyzed and tested for comparison. The pyrolysis set-up 200 is shown in FIG. 2. The fiber membranes were placed on a stainless-steel wire mesh plate (McMaster Carr, Robbinsville, NJ) and loaded into in a quartz tube (National Scientific Company, GE Type 214 quartz tubing, Quakertown, PA, USA), which was placed into a three-zone furnace 210 (Thermocraft, Inc., model #XST-3-0-24-3C, Winston-Salem, NC) connected with a multichannel temperature controller (Omega Engineering, Inc., Stamford, CT). The entire system was purged with ultra-high purity (UHP) argon for a minimum of 12 hours until O₂ level in the furnace dropped below 1 ppm. The fiber membranes were pyrolyzed with continuous purge of UHP argon (500 cc/min) using the temperature protocol given in Table 7 and Table 8. 550° C., 675° C. and 800° C. were investigated as the final temperature. There was no soaking at 400° C. in Table 7, which is a regular pyrolysis protocol without soaking at 400° C., and the resultant CMS was defined as NS-T_{final} CMS. For instance, the CMS prepared from 550° C. final temperature was named as NS-550 CMS membrane. 400° C. soaking for 1 hour was also investigated and the temperature protocol is shown in Table 8. Likewise, the resultant CMS was defined as S-T_{final} CMS. The furnace was naturally cooled to room temperature after the heating protocol was completed.

TABLE 7
Temperature protocol for pyrolysis of dual-layer fiber
membranes without soaking at 400° C.

| T₁ (° C.) | T₂ (° C.) | Ramp rate (° C./min) |
|---|---|---|
| 50 | 250 | 13.3 |
| 250 | T_{fianl} − 15 | 3.85 |
| T_{final} − 15 | T_{final} | 0.25 |
| T_{final} | T_{final} | 2 hours soak |

TABLE 8
Temperature protocol for pyrolysis of dual-layer fiber membranes
with soaking at 400° C.

| T₁ (° C.) | T₂ (° C.) | Ramp rate (° C./min) |
|---|---|---|
| 50 | 400 | 13.3 |
| 400 | 400 | 1 hour soak |
| 400 | T_{fianl} − 15 | 3.85 |
| T_{final}-15 | T_{final} | 0.25 |
| T_{final} | T_{final} | 2 hours soak |

### Permeation Measurements of Hollow Fiber Membranes

All 50:50 CO₂/CH₄ mixed gas permeation tests were done at 35° C. using the constant-pressure permeation method disclosed in U.S. Pat. No. 10,500,548. A 50 mol % CO₂ and 50 mol % CH₄ binary mixture with 114 psi was introduced to the shell-side of the hollow fiber membrane and the downstream was kept at atmospheric pressure. The permeate was measured by a bubble flowmeter and composition was analyzed by a gas chromatograph (Varian 450-GC) to calculate the selectivity. The stage cut was set to be lower than 1% to eliminate any effects of concentration polarization. Replicates were tested for all conditions described in the subsequent sections to ensure data reproducibility. Due to the very slow permeation rate for the larger molecules, such as N₂ and CH₄, gas permeation tests of CMS with pure gases were conducted using 150 psi. The permeance (P/L) can be calculated using the following equation 1:

$$\frac{P}{L} = 1 {0}^{6} \cdot \frac{{Q}_{P} \cdot 27 \; 3.15}{A \cdot T \cdot Δ p \cdot 5.17} \qquad ( 1 )$$

where P is permeability (1 Barrer=10⁻¹⁰ cm³ (STP) cm cm⁻² s⁻¹ cmHg⁻¹), L is membrane thickness (μm), Qₚ is the permeate flow rate in mL/sec, A is the active membrane area in cm², T is the room temperature in Kelvin, Δp is the transmembrane pressure difference in psia. The calculated permeance is in “Gas Permeation Units” (GPU) defined as:

$$1 GPU = 1 \times 1 {0}^{- 6} \frac{{cm}^{3} ( stp )}{{cm}^{2} \cdot s \cdot cm Hg} \qquad ( 2 )$$

To characterize the separation performance of a hollow fiber membrane, two key factors, termed as permeance and selectivity, can be considered. The permeance, Pᵢ/L, represents the separation productivity of a hollow fiber membrane and is defined as the flux of penetrant i normalized by the partial pressure or fugacity difference across the membrane, as shown in Equation 3,

$$\frac{{P}_{i}}{L} = \frac{{n}_{i}}{Δ {p}_{i}} \qquad ( 3 )$$

In equation 3, Pᵢ represents the permeability of penetrant i; L describes the effective membrane thickness; nᵢ represents the flux of penetrant i through the membrane; Δpᵢ refers to the partial pressure or fugacity difference of each penetrant across the membrane. The selectivity, αᵢⱼ, measures the membrane separation efficacy for a gas pair under conditions where the upstream pressure is much greater than the downstream. It is defined by the ratio of the fast gas (i) permeance to the slow gas (j) permeance, as shown in Equation 4,

$${α}_{ij} = \frac{{P}_{i} / L}{{P}_{j} / L} \qquad ( 4 )$$

### Membrane Morphology Characterization

Zeiss Ultra60 Fe-SEM was used to characterize the morphologies of polymer precursor hollow fibers and CMS hollow fibers. Polymer precursor samples were prepared by immersion in hexane followed by fracturing in Liquid Nitrogen. CMS samples were prepared by simply fracturing them by hand. All samples were put on carbon tape and attached on suitable SEM stubs. The polymer samples were sputter coated with gold using Hummer 6 Gold/Palladium Sputterer for 5 min to avoid sample charging. CMS samples did not require any sputter coating.

### Matrimid®/Matrimid® 5218-1+SiO₂ Dual-Layer Hollow Fiber CMS Membrane Preparation and Characterization

The Matrimid®/Matrimid® 5218-1+SiO2 dual-layer hollow fibers were similar to the 6FDA:BPDA-DAM/Matrimid® 5218-1+SiO2 dual-layer hollow fiber membranes. The dope composition and spinning parameters were listed in Table 9 and Table 10, respectively. The CMS preparation, permeation measurement, and morphology characterization were the same as the processes described above. The precursor fiber membranes were soaked in water for up to 4 weeks to remove residual solvents and additives.

TABLE 9
Dope composition of core spinning dope and sheath spinning dope
to spin Matrimid ® 5218-1/Matrimid ® 5218-1 dual-layer fiber
membranes (the 4^{th} spinning batch, SP-4).
Dope composition

| | Sheath (Matrimid ® 5218-1) | Core (Matrimid 5218-1) |
|---|---|---|
| Component | Wt. % | Wt. % |
| polymer | 26.2 | 18.2 |
| NMP | 53.0 | 69.8 |
| THF | 5.9 | 0.0 |
| Ethanol | 14.9 | 0.0 |
| PEG | 0.0 | 6.2 |
| LiNO₃ | 0.0 | 1.0 |
| SiO₂ | 0.0 | 4.8 |

TABLE 10
Spinning parameters and O₂/N₂ separation performance for Matrimid ®
5218-1/Matrimid ® 5218-1 dual-layer hollow fiber membranes (the 4^{th}
spinning batch, SP-4).

| Spinning parameter and | | | |
|---|---|---|---|
| O₂/N₂ separation | | | |
| performance | ST 1 | ST 2 | ST 3 |
| Spinning temperature (° C.) | 65 | 65 | 65 |
| Quench bath temperature | 50 | 50 | 50 |
| (° C.) | | | |
| Sheath dope flow rate | 40 | 10 | 20 |
| (cc/h) | | | |
| Core dope flow rate (cc/h) | 360 | 180 | 180 |
| Bore fluid flow rate (cc/h) | 120 | 60 | 60 |
| Air gap (cm) | 10 | 4 | 4 |
| Fiber take-up rate (m/min) | 30 | 11 | 11 |
| O₂ permeance (GPU) | 30.1 | 1373.9 | 133.9 |
| N₂ permeance (GPU) | 9.4 | 1439.7 | 97.7 |
| α_{O2/N2} | 4.03 | 0.96 | 1.37 |

### 5.0 Results and Discussion

Here, we consider three 6FDA:BPDA-DAM/Matrimid® 5218-1+SiO₂ dual-layer hollow fiber spinning cases (SP-1; SP-2 and SP-3), and detailed spinning information for these cases is listed in the Tables (Table 1-Table 6). For SP-1, low sheath dope extrusion rate (3 cc/h) with 20 m/min fiber take-up rate was used to create thin sheath layer precursor fibers. Without DETDA/TMC hybridization, the CMS for 550° C. gave 3230±161 GPU CO₂ with CO₂/CH₄ selectivity of 1.1 (Table 11). The CO₂/CH₄ selectivity increased to 4.6±0.2 after 2% DETDA/TMC hybridization; however, higher pyrolysis temperatures up to 800° C. did not increase the CO₂/CH₄ selectivity. This result indicates that the SP-1 precursor fibers were so defective that it was inconvenient to seal the defects using DETDA/TMC hybridization.

TABLE 11
Separation performance of CMS membranes using the 1^{st} spinning batch
of 6FDA: BPDA-DAM/Matrimid ® 5218-1 for CO₂/CH₄ separation.

| DETDA/TMC | Times of | Pyrolysis | | |
|---|---|---|---|---|
| concentration | DETDA/TMC | temperature | | |
| (%) | hybridization | (° C.) | P_{CO2} (GPU) | α_{CO2/CH4} |
| 0 | 0 | NS-550 | 3230.4 ± 161.6 | 1.1 ± 0.0 |
| 2 | 1 | NS-550 | 344.7 ± 26.7 | 4.6 ± 0.2 |
| 2 | 1 | NS-800 | 314.1 ± 12.3 | 2.1 ± 0.2 |

In SP-1, LiNO₃ was used as pore former for the sheath dope. To reduce defect formation tendency, LiNO₃ was eliminated for SP-2, while adjusting other components with similar ratios from the SP-1 composition. Different sheath flow rates were studied in SP-2 with other parameters kept constant. Four states (STs) of precursor fibers were collected and tested with pure O₂ and N₂, and results in Table 4 indicate that all of the precursor fibers were defective. Without DETDA/TMC hybridization, the CMS membrane fabricated from these four STs gave low CO₂/CH₄ selectivity 3.8±2.7 to 5.5±1.4 (shown in Table 12), verifying their defective natures. Next, ST 3 precursors from SP-2 batch were chosen for further study due to their higher CO₂ permeance (723.5±218.4 GPU, shown in Table 12) with relatively high CO₂/CH₄ selectivity (4.3±2.1). Nevertheless, even after 1% DETDA/TMC hybridization and final pyrolysis temperature up to 675° C., the CO₂/CH₄ selectivity remained low (5.2±2.2). This result shows that higher pyrolysis temperatures alone cannot heal significantly defective selective layers for the CO₂/CH₄ pair the CMS membrane, due to insufficient tightening at the higher temperatures. It was hypothesized that insufficient support core layer shrinkage occurred, due to suppression from the nano-particle fillers during standard heating. To tailor core layer shrinkage, a convenient 1-hr thermal soaking step at 400° C. soaking step was applied during the heating process. In the discussion and tables here, “NS” refers to the non-soaked and “S” refers to the 1-hr 400° C. thermal soaked protocol, e.g, in Table 12-14 NS-675 and S-675 refer to a “non-soaked” and “soaked” pyrolysis protocol, respectively with maximum pyrolysis temperature of 675° C. The movement of polymer segments can occur above the glass transition temperature (T_{g}). The core layer may relax in a subtle manner during the soaking at 400° C., well above the 305° C. T_{g} of Matrimid®. As results shown in Table 12, CMS from pyrolyzed at 675° C. with the 400° C. soaking had higher CO₂/CH₄ selectivity (8.9±1.5) than CMS at 675° C. without soaking (5.2±2.2) after 1% DETDA/TMC hybridization. This indicates that 400° C. soaking is beneficial for the nanoparticle-filler-containing composite CMS formation for higher CO₂/CH₄ selectivity.

TABLE 12
Separation performance of CMS membranes using the 2^{nd} spinning batch
of 6FDA: BPDA-DAM/Matrimid ® 5218-1 for CO₂/CH₄ separation.

| | DETDA/ | Times of | | | |
|---|---|---|---|---|---|
| | TMC | DETDA/ | Pyrolysis | | |
| | concentration | TMC | temperature | | |
| Fiber | (%) | hybridization | (° C.) | P_{CO2} (GPU) | α_{CO2/CH4} |
| ST 1 | 0 | 0 | NS-550 | 296.2 ± 43.6 | 4.3 ± 0.9 |
| ST 2 | 0 | 0 | NS-550 | 292.5 ± 133.9 | 5.5 ± 1.4 |
| ST 3 | 0 | 0 | NS-550 | 723.5 ± 218.4 | 4.3 ± 2.1 |
| ST 4 | 0 | 0 | NS-550 | 778.5 ± 300.6 | 3.8 ± 2.7 |
| ST 3 | 0 | 0 | NS-675 | 874.8 ± 62.8 | 2.4 ± 0.2 |
| ST 3 | 1 | 1 | NS-675 | 340.0 ± 41.4 | 5.2 ± 2.2 |
| ST 3 | 0 | 0 | S-675 | 907.3 ± 0.8 | 3.4 ± 0.4 |
| ST 3 | 1 | 1 | S-675 | 395.0 ± 57.5 | 8.9 ± 1.5 |

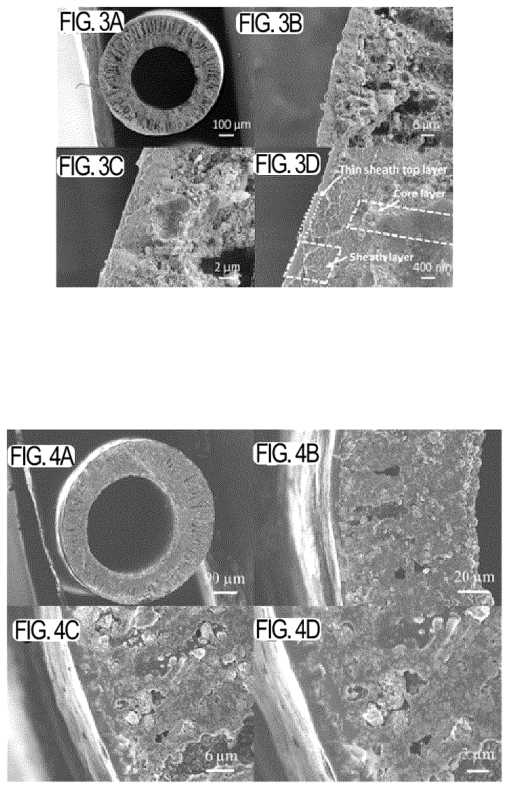

To obtain nanoparticle-filler-containing composite precursor with fewer defects, SP-3 fibers were spun with lower take-up rate (7 m/min, shown in Table 6). ST 5 of SP-3 precursor has the highest O₂/N₂ selectivity (1.59) exceeding even ST 4, which has a much thicker sheath layer (30 cc/h sheath flowrate vs. 10 cc/hr for ST 5). Table 13 shows that without DETDA/TMC hybridization, ST 5 pyrolyzed at 675° C. gave CO₂/CH₄ selectivity of 12.4±0.9 with 436.1±40.3 GPU CO₂—clearly superior to ST 4 CMS (CO₂/CH₄ selectivity of 4.1±0.7 with 362.2±22.0 GPU CO₂). Moreover, after 1% DETDA/TMC hybridization, ST 5 derived CMS showed CO₂/CH₄ selectivity of 36.6±1.8 with 244.6±21.8 GPU CO₂—again superior to ST 4 derived CMS with the same 1% DEDTA/TMC treatment. A thicker sheath appears not to be the key. FIGS. 3A & 3B show the 1% DETDA/TMC treated ST 5 precursor fiber has a uniform sheath layer with thin outer sheath, shown in more detail in FIGS. 3C and 3D. Overall, such a precursor is appealing for CMS development. More SEM images of the resultant CMS membranes (shown in FIGS. 4A-4D) appear excellent. It is noted, however, that the 6FDA:BPDA-DAM CMS derived from 675° C. by dip-coating (55.7±11.6) exceeds the CO₂/CH₄ selectivity (36.6±1.8). To pursue higher CO₂/CH₄ selectivity with still appealing CO₂ permeance, higher pyrolysis temperature of 800° C. with 400° C. soaking was employed. Without DEDTA-TMC treatment, it was found CO₂/CH₄ selectivity of 6.3±0.6 with 100.6±8.6 GPU CO₂ (shown in Table 13), showing the expected selective layer densification with lower CO₂ permeance.

TABLE 13
Separation performance of CMS membranes using the 3^{rd} spinning batch
of 6FDA: BPDA-DAM/Matrimid ® 5218-1 for CO₂/CH₄ separation.

| | DETDA/ | Times of | | | |
|---|---|---|---|---|---|
| | TMC | DETDA/ | Pyrolysis | | |
| | concentration | TMC | temperature | | |
| Fiber | (%) | hybridization | (° C.) | P_{CO2} (GPU) | α_{CO2/CH4} |
| ST 4 | 0 | 0 | S-675 | 362.2 ± 22.0 | 4.1 ± 0.7 |
| ST 5 | 0 | 0 | S-675 | 436.1 ± 40.3 | 12.4 ± 0.9 |
| ST 4 | 1 | 1 | S-675 | 114.8 ± 19.9 | 31.7 ± 6.0 |
| ST 5 | 1 | 1 | S-675 | 244.6 ± 21.8 | 36.6 ± 1.8 |
| ST 4 | 1 | 1 | S-800 | 100.6 ± 8.6 | 6.3 ± 0.6 |
| ST 5 | 1 | 1 | S-800 | 29.6 ± 3.3 | 35.2 ± 2.3 |
| ST 5 | 0 | 0 | S-550 | 656.2 ± 61.3 | 9.9 ± 1.1 |
| ST 5 | 0 | 0 | S-800 | 100.6 ± 8.6 | 6.3 ± 0.6 |
| ST 5 | 1 | 1 | S-550 | 290.6 ± 28.9 | 29.4 ± 6.4 |

However, the CO₂/CH₄ selectivity was even lower than the CMS from 675° C. without DEDTA-TMC treatment (CO₂/CH₄ selectivity of 12.4±0.9 with 436.1±40.3 GPU CO₂ seen in Table 13). It is hypothesized that imperfect carbon plates packing remained in the 800° C. CMS—as reflected by lack of improvement in size discrimination ability compared to the 675° C. CMS. Most surprising, however, was the impact of DEDTA-TMC treatment in Table 13 for ST 5 of the 800° C. pyrolyzed CMS. Specifically, negligible change in CO₂/CH₄ selectivity (36.6±1.8 at 675° C. vs. 35.2±2.3 at 800° C. pyrolysis) and a drastic drop in CO₂ permeance (from 244.6±21.8 GPU at 675° C. vs. 29.6±3.3 GPU at 800° C.) pyrolysis is seen in Table 13. These results suggested excessive loss in free volume is acting.

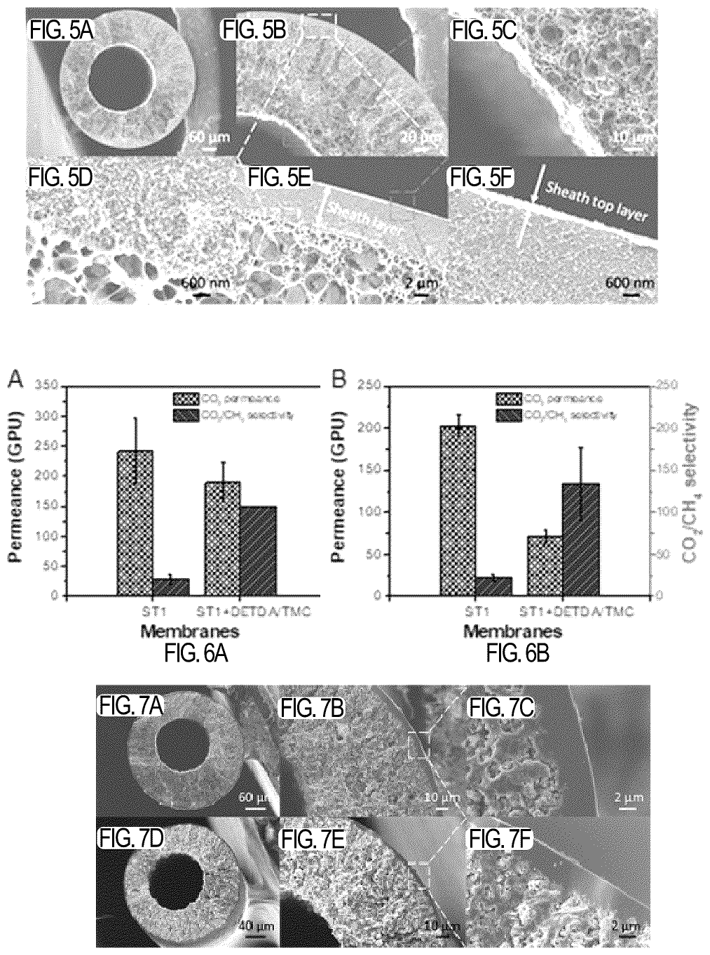

Besides 6FDA:BPDA-DAM as sheath layer, it was subsequently explored using a simple and economical Matrimid® 5218-1 sheath layer based on similar nanoparticle-filler-containing composite CMS membranes with the optimized 400° C. soak noted above. During optimization for the Matrimid® 5218-1 sheath, it was found that the core layer porosity could be tuned with poly(ethylene oxide) (PEO) in the core layer dope as a pore former. As is shown in FIGS. 5A-5F, the optimized core layer is highly porous with micro-scale pores. FIG. 5D shows a clear in-tact interface between the core layer and the sheath layer. The core layer contains large pores which were formed with the help from PEG. On top of the sheath layer, there is a ˜200 nm dense sheath top layer shown in FIG. 5F, which gave O₂/N₂ selectivity of 4.03. Without DETDA/TMC hybridization, the CMS membranes prepared from ST 1 showed low CO₂/CH₄ selectivity (4.9-22.9), shown in FIG. 6A, FIG. 6B and Table 14. After the DETDA/TMC hybridization, however, the CO₂/CH₄ selectivities increased to 64.3±0.2 and 134.2±43.2 for 550° C. and 675° C. pyrolysis, respectively. As expected the higher pyrolysis temperature gives lower CO₂ permeance (189.5±32.5 GPU vs 71.1±8.1 GPU for 550° C. and 675° C. pyrolysis, respectively). FIGS. 7A-7F show the SEM images of the CMS membranes from 550° C. and 675° C. Both cases show a dense carbon separation layer was formed from the sheath layer. Porous structures were maintained in the core layer due to the collapse suppression from the nano-particle-fillers.

TABLE 14
Separation performance of CMS membranes using the 4^{th} spinning batch
of Matrimid ® 5218-1/Matrimid ® 5218-1 for CO₂/CH₄ separation.

| | DETDA/ | Times of | | | |
|---|---|---|---|---|---|
| | TMC con- | DETDA/ | Pyrolysis | | |
| | centration | TMC | temperature | | |
| Fiber | (%) | hybridization | (° C.) | P_{CO2} (GPU) | α_{CO2/CH4} |
| ST 1 | 0 | 0 | NS-550 | 111.3 ± 9.5 | 6.2 ± 1.1 |
| ST 1 | 0 | 0 | S-550 | 241.7 ± 54.8 | 12.3 ± 3.6 |
| ST 1 | 0 | 0 | S-675 | 203.8 ± 12.1 | 22.9 ± 3.5 |
| ST 1 | 0 | 0 | S-800 | 44.5 ± 6.2 | 4.9 ± 2.2 |
| ST 1 | 1 | 1 | S-550 | 189.5 ± 32.5 | 64.3 ± 0.2 |
| ST 1 | 1 | 1 | S-675 | 71.1 ± 8.1 | 134.2 ± 43.2 |
| ST 1 | 1 | 1 | S-800 | 19.4 ± 2.4 | 57.6 ± 65.0 |

Comparison of CO₂ permeance and CO₂/CH₄ selectivity of various CMS hollow fiber membranes, including the CMS membranes discussed here, is in Table 15. By comparison, our CMS fiber from ST1 (SP-4 Matrimid® 5218-1/(Matrimid® 5218-1+SiO₂)) with 1% DETDA/TMC hybridization at S-675° C. showed excellent selectivity and promising permeance. Although 6FDA based composite CMS tended to give higher permeance, material cost is also higher than the Matrimid® 5218-1 used here. Most importantly, the nano-particle-filler enables high performance CMS membrane without V-treatment. Moreover, the DETDA/TMC hybridization & defect sealing in the precursor fiber is much simpler and more scalable than the dip-coating process. CMS membranes from ST5 (SP-3, 6FDA:BPDA-DAM/Matrimid® 5218-1 with 1% DETDA/TMC hybridization at S-675) showed higher CO₂/CH₄ selectivity, 36.6 vs. 25.0 for the monolithic 6FDA:BPDA-DAM CMS with VTMS-treatment. The CO₂ permeance (244.6 GPU) of the ST5 (SP-3) is lower than the monolithic 6FDA:BPDA-DAM CMS (400.0 GPU). The PEO pore former has not been explored yet for the 6FDA:BPDA-DAM/Matrimid® 5218-1 precursor fiber membranes. It is expected that the CMS core layer may be more open from the PEO containing core dope spinning with higher achievable permeance CMS as compared to the monolithic CMS.

TABLE 15
Separation performance comparison of CMS hollow
fiber membranes for CO₂/CH₄ separation.^{[17]}

| | Pyrolysis | Feed | Feed | Feed | | |
|---|---|---|---|---|---|---|
| | T | T | P | CO₂/CH₄ | P_{CO2} | |
| Item description | (° C.) | (° C.) | (bar) | composition | (GPU) | αCO₂/CH₄ |
| CMS derived from | 650 | 35 | 6.9 | 50/50 | 40 | 100 |
| Matrimid ® | | | | | | |
| CMS derived from PMDA- | 600 | 25 | 7.0 | Pure gas | 93.4 | 19.8 |
| ODA | | | | | | |
| CMS derived from | 650 | 25 | 6.9 | Pure gas | 1.66 | 55.33 |
| PEI(Ultem 1000)/PVP | | | | | | |
| CMS derived from PIM-1 | 575 | 35 | 6.9 | Pure gas | 20 | 153.8 |
| CMS derived from | 900 | 40 | 70 | Pure gas | 0.276 | 38.90 |
| P84 ® | | | | | | |
| CMS derived from | 900 | 40 | 70 | Pure gas | 6.3 | 20.86 |
| Matrimid ® | | | | | | |
| CMS derived from | 550 | 35 | 6.9 | 50/50 | 1177 | 36.7 |
| Sheath/core | | | | | | |
| Matrimid ®/Matrimid ® | | | | | | |
| composite | | | | | | |
| CMS derived from | 550 | 35 | 6.9 | 50/50 | 2546 | 24.1 |
| Sheath/core 6FDA:BPDA- | | | | | | |
| DAM/Matrimid ® composite | | | | | | |
| CMS derived from PI- | 675 | 35 | 1 | Pure gas | 956 | 50.2 |
| LPSQ20 | | | | | | |
| CMS derived from | 550 | 35 | 6.9 | 50/50 | 400 | 25 |
| 6FDA:BPDA-DAM | | | | | | |
| CMS-675 derived from dip | 675 | 35 | 6.9 | 50/50 | 310 | 58.8 |
| coated on P84 ®/P84 ® | | | | | | |
| composite | | | | | | |
| CMS-800 derived from dip | 800 | 35 | 6.9 | 50/50 | 166.7 | 86.5 |
| coated on P84 ®/P84 ® core | | | | | | |
| CMS derived from 6FDA- | 800 | 35 | 6.9 | 50/50 | 167.9 | 86.9 |
| DAM/Matrimid ® at 800° C. | | | | | | |
| CMS derived from 6FDA- | 675 | 35 | 6.9 | 50/50 | 232.5 | 64.3 |
| DAM/Matrimid ® at 675° C. | | | | | | |
| CMS derived from | 675 | 35 | 6.9 | 50/50 | 244.6 | 36.6 |
| 6FDA:BPDA-DAM/ | | | | | | |
| (Matrimid ® + SiO₂) at 675° C. | | | | | | |
| CMS derived from | 550 | 35 | 6.9 | 50/50 | 189.5 | 64.3 |
| Matrimid ®/(Matrimid ® + SiO₂) | | | | | | |
| CMS at 550° C. | | | | | | |
| CMS derived from | 675 | 35 | 6.9 | 50/50 | 71.1 | 134.2 |
| Matrimid ®/(Matrimid ® + SiO₂) | | | | | | |
| CMS at 675° C. | | | | | | |

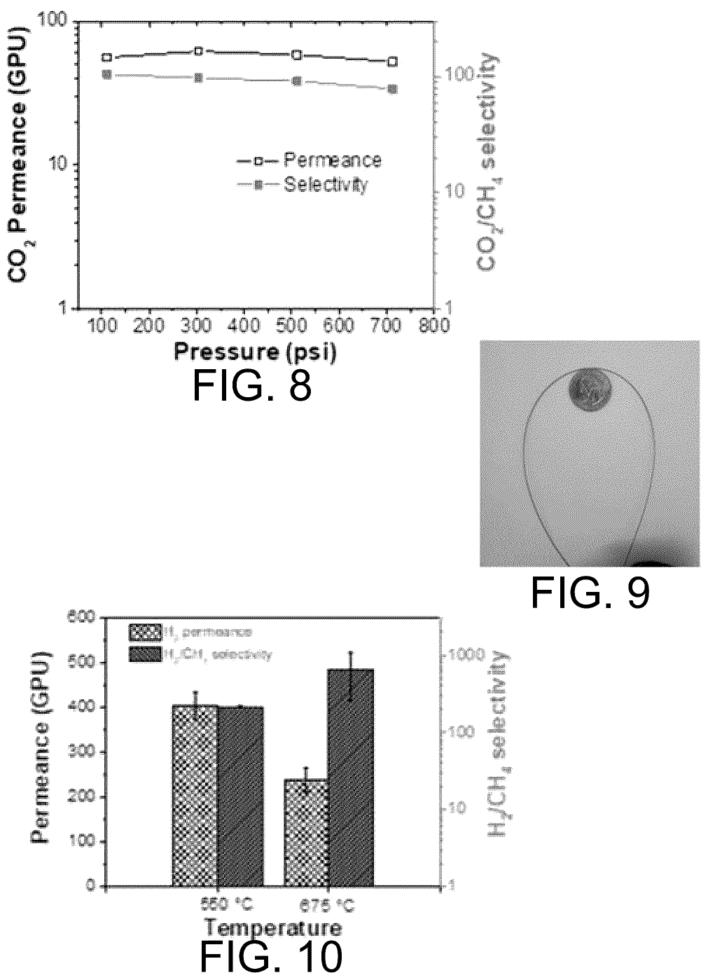

The high modulus of e CMS avoids mechanical problems with is nano-particle-filler support composite CMS even at elevated pressure up to 700 psi. (FIG. 8 shows the permeation data at different pressures for 120-day aged modules pyrolyzed at S-675 with 1% DETDA/TMC hybridization). It is also significant that the hollow fiber CMS membrane is mechanically robust, with capability to form a loop around a <1.5 cm (radius) as shown in FIG. 9. This appealing flexibility should be sufficient to prepare modules for commercial applications. This proof-of-concept study shows opportunities for a new generation of CMS membranes based on the nano-particle-filler support composite that can eliminate the sol-gel V-treatment step and no defect-free precursor fiber membranes are required prior to the pyrolysis. This approach significantly decreases the spinning difficulty and simplifies the CMS fabrication process.

Higher temperature pyrolysis usually gives higher selectivity since further tuning the separation layer as the ultramicropore distribution shifts to smaller sizes. Here it was found the CMS membranes from 800° C. with 400° C. soaking showed a CO₂/CH₄ selectivity of 57.6±65.0 with 19.4±2.4 GPU CO₂ permeance based on three single fiber module tests. However, only one module gave CO₂/CH₄ selectivity of 149.3 with 17.2 GPU CO₂. The other two modules showed CO₂/CH₄ selectivity of 6.8 and 16.7, respectively.

A final topic relates to H₂/CH₄, which is of interest to pursue hydrogen extraction modules (HEMs) to enable hybrid H₂+CH₄ pipelines for the future energy system. H₂ mainly comes from fossil fuel related processes, such as natural gas steam reforming, petrochemical refinery, purge gas recovery and so on. Even in such cases, H₂/CH₄ separation is a critical step, so H₂/CH₄ separation performance was explored. As shown in FIG. 10, the 675° C. CMS with 400° C. soaking from 1% DETDA/TMC hybridized ST 1 (SP-4) membranes give H₂/CH₄ selectivity of 662.6±400.5 with H₂ permeance of 239.6±27.8 GPU. A lower final pyrolysis temperature at 550° C. with 400° C. soaking gives lower H₂/CH₄ selectivity of 214.4±8.9 with higher H₂ permeance of 405.4±30.8 GPU. It is noteworthy that the 675° C. pyrolyzed sample here with nanoparticle core and DETDA+TMC exceeds the selectivity of the previous non-DETDA+TMC sample. This suggests that the DETDA+TMC hybridized defect healed selective layer offers selectivity advantages over the unhybridized precursor. Table 16 shows the results of membranes with various materials for H₂/CH₄ separation. The present CMS membranes achieved from ST 1 (SP-4) with DETDA+TMC treatment have an attractive performance.

TABLE 16
Separation performance of typical membranes for H₂/CH₄ separation.

| | | Test | H₂ | |
|---|---|---|---|---|
| | | temperature | permeance | H₂/CH₄ |
| Membrane materials | | (K) | (GPU) | selectivity |
| Zeolite | SSZ-13 | 298 | 13,400 | 75.0 |
| | SOD | 523 | 119 | 23.0 |
| | Si—CHA | 298 | 4,300 | 85.0 |
| MOF | 2D ZIF-95 | 373 | 3,258 | 54.0 |
| | ZIF-8@GO | 523 | 388 | 139.0 |
| Polymer | PIM-1 | 308 | 350 | 21.9 |
| | PIM-1/Matrimid ® | 308 | 5 | 116.2 |
| | Commercial | — | 150 | 40.0 |
| | polyimide | | | |
| | membrane | | | |
| CMS | CMS-900 | 393 | 48 | 1,859 |
| | CMS | — | 137 | 264.0 |
| | CMS | 308 | 8* | 40,350 |
| | CMS | 308 | 239.6 | 662.6 |

Note:
*permeance is calculated by permeance = Permeability/membrane thickness

Two different polyimide polymers were disclosed as sheath polymers to fabricate the nano-particle-filler-containing composite precursor fiber membranes. Defects in such pristine membranes were able to be mitigated, enabling creation of high performance CMS due to the anti-collapse properties of the nano-particle-fillers. Defects in the precursor membrane can be efficiently sealed using DETDA/TMC hybridization to give high performance CMS membranes. The Matrimid®-based sheath seems easier use to give higher performance CMS membranes since defects presumably can be eliminated during the glass-rubbery transition. This approach shows defect-free composite nano-particle-filler containing composite precursors appear unnecessary for the CMS needs as long as DETDA/TMC hybridization posttreatment is applied. The disclosed approach greatly decreases the spinning difficulty. Conventional CMS anti-collapse technology can be eliminated with assistance from the nano-particle-fillers. Different sheath polymers and core polymers can also be employed. Combinations can be used to fabricate high performance CMS membrane by approaches noted below, which are used as compositions of matter:
PEO as pore former for composite with or without nanoparticles;
DETDA/TMC hybridization; and
thermal soaking above the Tg of the appropriate core polymer.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described herein, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of fabricating high performance CMS membranes, comprising the steps of:
(a) extruding a dual-layer hollow fiber precursor fiber membrane that contains a nano-particle-filler containing core layer;
(b) co-extruding a sheath layer with the core layer so that at least a portion of the core layer is surrounded by the sheath layer;
(c) defect sealing nano-particle filler; and
(d) pyrolysing the dual-layer hollow fiber precursor fiber and the sheath layer.

2. The method of claim 1, wherein the core layer comprises a thermoplastic polyimide.

3. The method of claim 2, wherein the thermoplastic polyimide comprises poly(ethylene oxide).

4. The method of claim 1, wherein the sheath layer comprises 6FDA:BPDA-DAM.

5. The method of claim 4, comprising the step of synthesizing 6FDA:BPDA-DAM by reacting 4,4′-(hexafluoroisopropylidene) diphthalic (6FDA) and 3,3′-4,4′-biphenyl tetracarboxylic acid (BPDA) dianhydrides with 2,4,6-trimethyl-1,3-diaminobenzene (DAM) in a condensation reaction.

6. A process for making CMS membranes comprising the steps of:
(a) co-extruding a dual-layer hollow fiber precursor fiber membrane that contains a nano-particle-filler containing core layer surrounded by a sheath layer;
(b) defect sealing the nano-particle-filler precursor fiber membrane; and
(c) pyrolysing the core layer and the sheath layer.

7. The process of claim 6, further comprising the step of soaking the precursor fiber membrane during the pyrolysis.

8. A CMS membrane, comprising:
(a) a core layer;
(b) a sheath layer surrounding at least a portion of the core layer; and
(c) a plurality of nanoparticles disposed in the core layer.

9. The CMS membrane of claim 8, wherein the core layer comprises poly(ethylene oxide) (PEO).

10. The CMS membrane of claim 8, wherein the sheath layer comprises 6FDA:BPDA-DAM.

11. The CMS membrane of claim 8, wherein the nanoparticles comprise silicon dioxide.
